(19) United States
(12) Patent Application Publication
(10) Pub. No.: US 2002/0145714 A1
(43) Pub. Date: Oct. 10, 2002

(54) Reticle chucks and methods for holding a lithographic reticle utilizing same

(75) Inventor: Noriyuki Hirayanagi, Tokyo-to (JP)

Correspondence Address: KLARQUIST SPARKMAN, LLP, One World Trade Center, Suite 1600, 121 S.W. Salmon Street, Portland, OR, 97204, US

(73) Assignee: Nikon Corporation

(21) Appl. No.: 10/086,513

(22) Filed: Feb. 28, 2002

(30) Foreign Application Priority Data
Apr. 5, 2001 (JP) 2001-107430

(51) Int. Cl. G03B 27/42

(52) U.S. Cl. 355/53

(57) ABSTRACT

Reticle-holding devices (“reticle chucks”) are disclosed that define a downstream-facing reticle-mounting surface configured for holding an upstream-facing surface of a reticle for use in a microlithography apparatus. The reticle chucks can include peripheral regions and struts that define respective portions of the reticle-mounting surface, thereby preventing reticle sag while still allowing the axial distance from the reticle to a projection-optical system to be measured by grazing incidence without obstruction. The reticle can be held by, e.g., electrostatic attraction or vacuum suction to the reticle-mounting surface. The subject chucks also can be used for holding a reticle blank while inscribing a pattern on the reticle blank.

### FIELD

This disclosure pertains to microlithography (transfer-exposure of a pattern from a mask or reticle to a substrate). Microlithography is a key technique used in the manufacture of microelectronic devices such as integrated circuits, displays, thin-film magnetic pickup heads, and micromachines. More specifically, the disclosure pertains to devices and methods for holding a pattern-defining reticle in a manner resulting in reduced sagging and other deformation of the reticle than conventionally.

### BACKGROUND

Conventional projection microlithography typically involves defining a pattern on a reticle or mask (generally termed a “reticle” herein), illuminating a region of the pattern on the reticle to form a “patterned beam” carrying a aerial image of the illuminated region, and passing the patterned beam through a projection-optical system to imprint the image on a “sensitized” surface of a substrate such as a semiconductor wafer. Most of the microlithography performed currently utilizes a deep-UV light beam as the lithographic beam. However, to achieve finer resolution than obtainable using deep-UV light, substantial effort is being expended to develop a practical “next generation” lithography technology utilizing a charged particle beam or “soft X-ray” (extreme UV) light beam.

In any of these projection-lithography technologies, passing the lithography beam through the reticle requires that the reticle be mounted on a reticle holder (“reticle chuck”) that, in turn, is mounted on a reticle stage. The reticle is held on an upstream-facing surface of the reticle chuck by electrostatic attraction or by vacuum. A conventional reticle chuck 2 is shown in FIG. 5. The reticle chuck 2 has a peripheral portion 2p that defines, on its upstream-facing “mounting surface” 2e, multiple vacuum orifices 2d. A reticle 1 is placed on the mounting surface 2e such that the under-surface of the reticle extends over the vacuum orifices 2d. The vacuum orifices 2d are connected to a suitable vacuum “source” (e.g., vacuum pump) that operates to reduce the pressure within the vacuum orifices 2d sufficiently to cause the reticle 1 to be attracted to, and thus secured to, the attachment surface 2e.

Current trends in the ongoing evolution of microlithographic technology include the use of progressively larger reticles, as well as changes in the materials from which reticles are made. As a result of these changes the reticles are more susceptible to deformation and sagging when peripherally mounted to a conventional reticle chuck. Reticle deformation of this nature results in a corresponding deterioration of the positional accuracy and configurational fidelity of the reticle pattern as projected onto the substrate.

To alleviate reticle sagging certain conventional reticle chucks are configured as shown in FIG. 6, in which the reticle chuck 12 includes a peripheral portion 12p defining a respective portion of a mounting surface 12e. Extending from the peripheral portion 12p are large struts 12a that are connected together at mid-length in a manner as shown serving to support middle portions of the reticle 1. (The upstream-facing surfaces of the struts 12a also define respective portions of the mounting surface 12e.) Between the struts 12a and peripheral portion 12p are open regions 12b. For mounting to such a reticle chuck 12, a reticle 11 is similarly configured with a peripheral portion 11p and struts 11a, as shown, with pattern-defining regions 11b situated between the struts 11a and peripheral portion 11p. Whenever the reticle 11 is mounted to the mounting surface 12e, the pattern-defining regions 11b are situated over and aligned with the open regions 12b.

The struts 11a of the reticle 11 cannot define any portion of the reticle pattern because, otherwise, the respective portions would be blocked by the struts 12a of the reticle chuck 12. Even though the struts 11a increase the rigidity of the reticle 11, the reticle must be correspondingly larger to accommodate the struts 11a.

For projecting an image of the pattern from the reticle to a substrate, a projection-optical system is situated between the reticle and the substrate. For achieving adequate focus of the pattern image on the substrate, the axial distance of the reticle from the projection-optical system must be accurately determined and controlled. The conventional manner of performing such a “reticle-height” determination utilizes a grazing-incidence laser beam. Considering the reticle 11 and reticle chuck 12 shown in FIG. 6, a conventional device for performing grazing-incidence height detection is situated downstream of the reticle 11. The device directs a laser beam that is incident at a grazing angle within the pattern-defining region 11b on an under-surface of the reticle 11.

For accurate reticle-height detection the laser beam must not be obstructed by any of the struts 12a or peripheral portion 12p of the reticle chuck 12. However, preventing such obstruction without compromising height detection at any location on the pattern-defining region 11b requires that the “members” 12a, 12p be as thin (and thus as non-obstructing to the laser beam) as possible. Unfortunately, making the members 12a, 12p as thin as possible reduces the overall rigidity of the reticle chuck 12. Consequently, the middle portions of the reticle chuck 12 tend to sag, which defeats the purpose of the struts 12a. The resulting deformation of the mounting surface 12e yields a corresponding inability of the reticle chuck 12 to hold the reticle 11 properly. Deformation of the mounting surface 12e also yields a corresponding deformation of the reticle 11, which causes a loss of pattern-transfer accuracy and fidelity.

### SUMMARY

The shortcomings of conventional reticle holders as summarized above are overcome by various aspects of the invention. As used herein, the term “reticle chuck” encompasses any of various holders configured for holding a reticle, especially for use in microlithography. The various reticle chucks disclosed herein can be used with any of various types of microlithography apparatus especially configured for use in projecting a pattern, defined by the reticle, onto a lithographic substrate using an energy beam. The energy beam can be a beam of electromagnetic radiation (e.g., deep UV light, extreme UV light, X-rays) or a beam of charged particles (e.g., electrons or ions).

According to a first aspect of the invention, reticle chucks are provided for use in a microlithography apparatus. For use, the reticle chuck is situated between an upstream illumination-optical system and a downstream projection-optical system of the microlithography apparatus. An embodiment of such a reticle chuck comprises a downstream-facing reticle-mounting surface and is configured to hold a reticle on the reticle-mounting surface. The reticle can be mounted to the reticle-mounting surface in any of various manners. For example, the reticle chuck can further comprise at least one electrostatic electrode situated relative to the reticle-mounting surface, wherein the electrode is configured to attract and to hold the reticle electrostatically to the reticle-mounting surface. Desirably, multiple electrodes distributed over the reticle-mounting surface are used. As another example, the reticle-mounting surface defines at least one vacuum orifice connected to a vacuum source, wherein the vacuum orifice(s) is configured to hold the reticle to the reticle-mounting surface by a gas-pressure differential from outside the vacuum orifice to inside the vacuum orifice. i.e., the vacuum “source” (e.g., vacuum pump) applies a vacuum to the vacuum orifice(s), and the resulting suction action causes the reticle to adhere to the reticle chuck. Desirably, multiple vacuum orifices distributed over the reticle-mounting surface are used.

The reticle chuck can further include a “catching member” situated and configured to catch and hold the reticle at least whenever the reticle has been unintentionally released in a downstream direction from the reticle-mounting surface. The catching member can have any of various configurations conferring an ability to prevent the reticle from falling from the reticle-mounting surface in a manner that would cause damage to the reticle. A catching member is especially useful if the associated microlithography apparatus has experienced a malfunction or unplanned power loss.

In an advantageous embodiment, the reticle chuck comprises a peripheral portion and at least one strut portion extending across an open region between opposing members of the peripheral portion. The peripheral portion and strut portion(s) define respective downstream-facing surfaces constituting respective portions of the reticle-mounting surface. With such a configuration, the reticle is mounted to the downstream-facing reticle-mounting surface around the periphery of the reticle, as well as to the strut portion(s), which eliminates sagging and other deformations of the reticle. With this configuration, multiple electrostatic electrodes can be situated relative to the reticle-mounting surface and configured to attract and to hold the reticle electrostatically to the reticle-mounting surface, wherein at least one respective electrode is associated with the downstream-facing surface of the peripheral portion and at least one respective electrode is associated with the downstream-facing surface of the strut portion. Alternatively, at least one respective vacuum orifice can be defined in the downstream-facing surface of the peripheral portion and at least one respective vacuum orifice defined in the downstream-facing surface of the strut portion.

Another aspect of the invention is directed to combinations of a reticle and a reticle chuck, wherein the combination is configured to be positioned between an upstream illumination-optical system and a downstream projection-optical system of a microlithography apparatus. In an exemplary embodiment the reticle chuck comprises a downstream-facing reticle-mounting surface and is configured to hold the reticle on the reticle-mounting surface. The reticle chuck can have any of various configurations as summarized above. The reticle can have any of various configurations allowing the reticle to be held by the reticle chuck. For example, the reticle can be fabricated from a reticle substrate selected from the group consisting of silicon, silicon compounds, glass, quartz, gold, and diamond. The reticle also can be a divided reticle such as a stencil reticle or a membrane reticle. In any event, as noted above, the reticle has an upstream-facing surface configured to be held on the reticle-mounting surface, and a downstream-facing surface. The downstream-facing surface desirably is a pattern-defining surface.

According to yet another aspect of the invention, microlithography apparatus are provided that comprise an illumination optical system, a projection-optical system, and a reticle-holding device defining a downstream-facing reticle-mounting surface. The reticle-holding device is situated between the illumination-optical system and the projection-optical system and configured to hold a reticle on the reticle-mounting surface. In one embodiment the reticle-holding device further comprises at least one electrostatic electrode situated relative to the reticle-mounting surface, wherein the at least one electrode is configured to attract and to hold the reticle electrostatically to the reticle-mounting surface. The apparatus of this embodiment can further comprise a power source connected to the at least one electrode and configured to provide electrical power to the at least one electrode whenever the reticle is to be attracted electrostatically to the reticle-mounting surface.

In an alternative embodiment, the reticle-mounting surface defines at least one vacuum orifice connected to a vacuum source and configured to hold the reticle to the reticle-mounting surface by a gas-pressure differential from outside the vacuum orifice to inside the vacuum orifice. The apparatus of this embodiment can further comprise a vacuum source connected to the at least one vacuum orifice and configured to reduce a gas pressure in the at least one vacuum orifice relative to a gas pressure outside the at least one vacuum orifice whenever the reticle is to be urged in contact with the reticle-mounting surface.

In general, in any of the apparatus according to this aspect of the invention, the reticle-holding device (i.e., the “reticle chuck”) can have any of the various reticle-chuck configurations summarized above.

Any of these apparatus can further include a reticle stage to which the reticle-holding device is mounted. The reticle stage is situated and configured to move the reticle-holding device in at least one dimension relative to the illumination-optical system and projection-optical system.

Any of these apparatus can further include a reticle-height-measurement device situated and configured to measure a distance from the reticle to the projection-optical system. The reticle-height measurement device desirably is configured to direct a laser beam at grazing incidence on the downstream-facing surface of the reticle. Because the reticle-mounting surface of the reticle-holding device faces in a downstream direction (i.e., toward the projection-optical system), measurement of the distance from the reticle to the projection-optical system is readily and easily performed. Also, any profile irregularities of the reticle-mounting surface can be measured and corrected easily as required.

The illumination-optical system and projection-optical system of these apparatus can be configured to pass any of various lithographic energy beams such as a charged particle beam or a beam of electromagnetic radiation.

Another aspect of the invention is directed, in the context of a method for performing microlithography in which an energy beam is passed through an illumination-optical system to a reticle and from the reticle through a projection-optical system to a substrate, to methods for holding the reticle relative to the energy beam. In an embodiment of such a method, a reticle chuck is situated between the illumination-optical system and the projection-optical system. The reticle chuck comprises a downstream-facing reticle-mounting surface configured for holding an upstream-facing surface of the reticle. The reticle is mounted to the reticle chuck. The step of mounting the reticle to the reticle chuck can comprise attaching the upstream-facing surface of the reticle to the reticle-mounting surface by electrostatic attraction. Alternatively, the step of mounting the reticle to the reticle chuck can comprise attaching the upstream-facing surface of the reticle to the reticle-mounting surface by vacuum suction.

As summarized earlier above, the reticle chuck can be configured with a peripheral portion and at least one strut portion extending across an open region between opposing members of the peripheral portion. The peripheral portion and strut portion define respective downstream-facing surfaces constituting respective portions of the reticle-mounting surface, wherein the step of mounting the reticle to the reticle chuck comprises attaching the upstream-facing surface of the reticle to the respective portions of the reticle-mounting surface on the peripheral portion and strut portion.

The foregoing and additional features and advantages of the invention will be more readily apparent from the following detailed description, which proceeds with reference to the accompanying drawings.

### BRIEF DESCRIPTION OF THE DRAWINGS

FIG. 1 is an oblique perspective view of a reticle chuck and reticle according to a representative embodiment.

FIG. 2 is an oblique perspective view of a portion of a pattern-defining region of the reticle shown in FIG. 1.

FIG. 3 is a schematic elevational view of a microlithography apparatus including a reticle chuck such as the embodiment shown in FIG. 1.

FIG. 4 is a schematic elevational view of an apparatus for inscribing a pattern on a reticle blank, the apparatus including a chuck such as the embodiment shown in FIG. 1.

FIG. 5 is an oblique perspective view of a first type of conventional reticle chuck, with respective reticle.

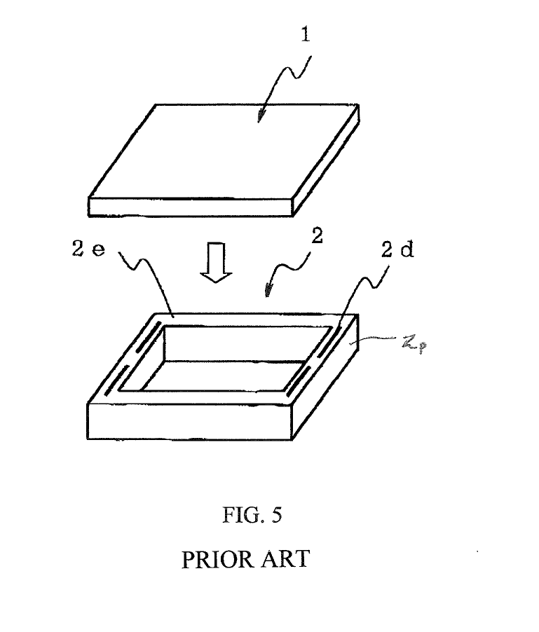

FIG. 6 is an oblique perspective view of a second type of conventional reticle chuck, with respective reticle.

### DETAILED DESCRIPTION

The invention is described below in the context of representative embodiments that are not intended to be limiting in any way.

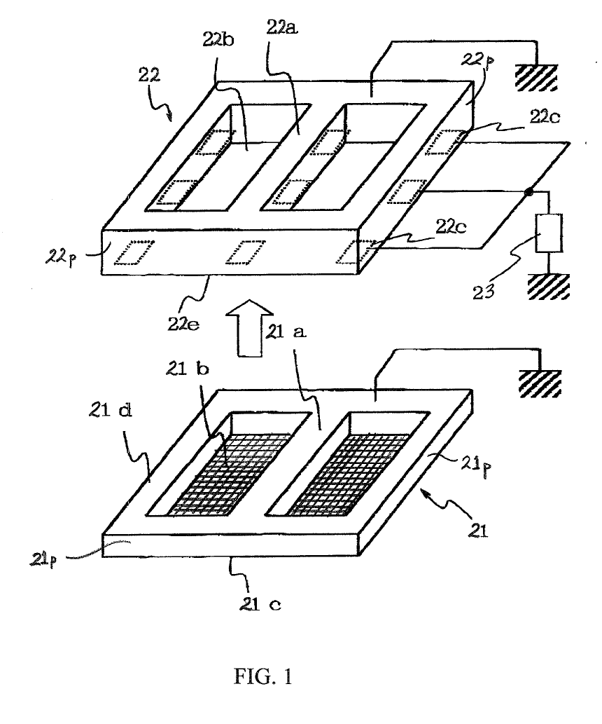

A representative embodiment of a reticle chuck 22 according to an aspect of the invention is shown in FIG. 1. Also shown is a reticle 21 configured to be mounted to the reticle chuck 22.

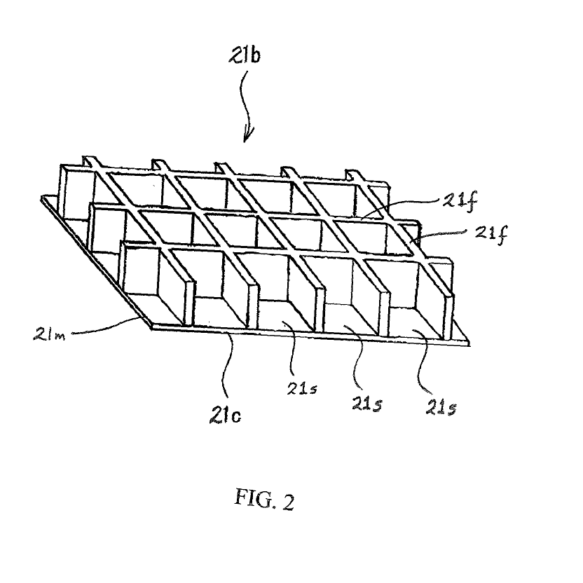

The reticle 21 includes a peripheral portion 21p and a large strut 21a extending between opposing members of the peripheral portion 21p, thereby forming, in the depicted configuration, two pattern-defining regions 21b. The reticle 21 also has an upstream-facing surface 21d and a downstream-facing surface 21c. Further detail of an exemplary pattern-defining region 21b of a reticle 21 especially configured for charged-particle-beam (CPB) microlithography is shown in FIG. 2. In the manner of a typical reticle for CPB microlithography, the reticle 21 depicted in FIG. 2 is “segmented” (also termed “divided”), wherein each of the pattern-defining regions 21b is divided into multiple “subfields” 21s each defining a respective portion of the overall pattern. The subfields 21s are separated from one another by minor struts 21f that collectively form a “grillage,” and each subfield 21s includes a respective portion of the pattern-defining reticle membrane 21m. The minor struts 21f typically extend from the membrane 21m in an upstream direction, and the “lower” surface of the membrane 21m constitutes the downstream-facing surface 21c of the reticle 21.

The reticle chuck 22 comprises a peripheral portion 22p and a large strut 22a extending between opposing members of the peripheral portion 22p, thereby forming, in the depicted configuration, two open regions 22b. The members 22a, 22p collectively define a downstream-facing mounting surface 22e. In the large struts 22a and certain members of the peripheral portion 22p are multiple electrostatic electrodes 22c situated just “beneath” (in the upstream direction) of the mounting surface 22e. The electrodes 22c are connected to a suitable grounded power source 23. The reticle chuck 22 and reticle 21 also are grounded.

The reticle 21 can be manufactured from a reticle substrate (typically a semiconductor wafer) using conventional methods. During manufacture of the reticle 21, the peripheral portion 21p and large strut 21a are defined, as well as the respective pattern-defining regions 21b (with grillage 21f) situated between the large strut 21a and peripheral portion 21p. As noted above, and referring to FIG. 2, a respective portion of the pattern is defined in or on the respective portion of the reticle membrane 21m in each subfield 21s. The respective pattern portion is defined in the membrane 21m as respective apertures in the case of a “stencil” reticle. In the case of a “scattering-membrane” reticle, the respective pattern portion is defined on the downstream-facing surface of the membrane 21m (while the grillage 21f extends upstream from the upstream-facing surface of the membrane 21m).

For mounting the reticle 21 to the reticle chuck 22, the reticle 21 is conveyed (e.g., by a suitable robotic device termed a “reticle loader,” not shown but well understood in the art) to a position just downstream of the reticle chuck 22. From such a position the reticle 21 is lifted “upward” by the reticle loader such that the upstream-facing surface 21d is brought into contact with the mounting surface 22e of the reticle chuck 22. At this time, energization of the electrodes 22c by the power source 23 causes the reticle 21 to be attracted electrostatically, and thus firmly attached, to the reticle chuck 22. The reticle loader is returned to a prescribed waiting position to allow use of the reticle for microlithography. Meanwhile, the reticle 21 remains held to the reticle chuck 22 with sufficient electrostatic force to support the dead weight of the reticle, thereby avoiding reticle sag. Because the electrodes 22c are situated not only in the peripheral portions 22p but also in the large strut 22a, the middle portion of the reticle 21 (specifically the large strut 21a) also is secured to the reticle chuck 22.

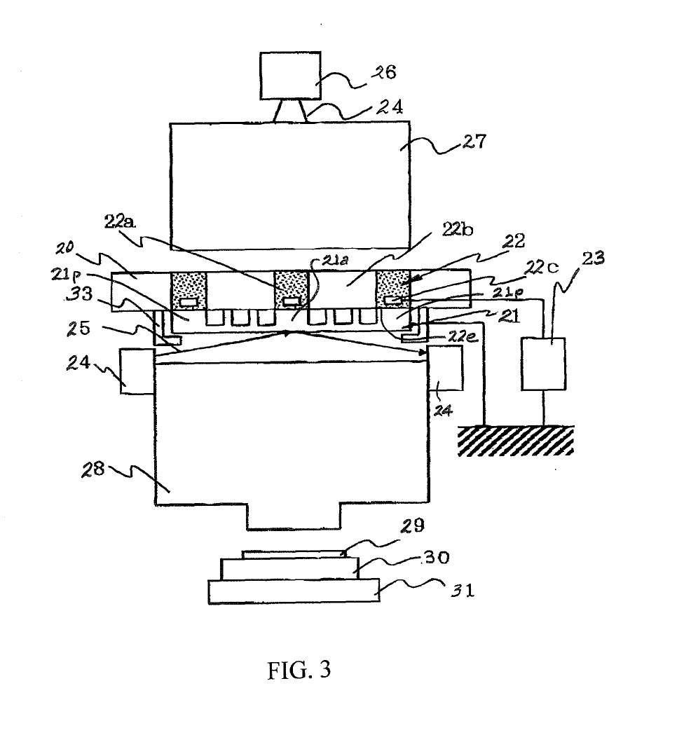

A representative embodiment of a microlithography apparatus including a reticle chuck 22 as shown in FIG. 1 is depicted in FIG. 3. The apparatus of FIG. 3 is depicted with a reticle 21 mounted to the reticle chuck 22. The depicted microlithography apparatus utilizes a charged particle beam (in particular, an electron beam) as the lithographic energy beam. Hence, an electron gun 26 or analogous beam-generation device is situated at an extreme upstream end of the apparatus. The electron gun 26 produces an illumination beam 24 that passes through an illumination-optical system 27 configured for shaping and directing the illumination beam to the reticle 21. The reticle chuck 22 is mounted on a reticle stage 20 situated just downstream of the illumination-optical system 27 and configured to move the reticle chuck 22 (with attached reticle 21) in three-dimensional space. As shown, the reticle chuck 22 is effectively embedded in the reticle stage 20.

In the manner shown in FIG. 1, electrodes 22c are arranged in multiple locations near the mounting surface 22e of the reticle chuck 22. The electrodes 22c are connected to a grounded power source 23. Also, the reticle chuck 22 itself is grounded. Thus, the reticle 21 is attracted electrostatically, at a prescribed force, to the mounting surface 22e of the reticle chuck 22. The reticle 21 is grounded. Mounted to the “under”-surface of the reticle stage 20 are opposing pawl-shaped catching members 33 configured to “catch” the reticle 21, in the event of an interruption of power supplied to the electrodes 22c, to prevent the reticle falling and becoming damaged.

Downstream of the reticle 21 is a projection-optical system 28 situated between the reticle 21 and a lithographic substrate 29. A reticle-height sensor 24 is situated just downstream of the reticle 21 and configured to measure the “height” of the reticle 21 from the upstream end of the projection-optical system 28. To such end, the reticle-height sensor 24 produces a measurement laser beam 25 that strikes the downstream-facing surface 21c of the reticle 21 at a grazing angle of incidence.

Downstream of the projection-optical system 28 is situated a substrate stage 31 configured to hold a “wafer chuck” 30 to which the substrate 29 is mounted. The substrate stage 31 also is configured to move the wafer chuck 30 in three-dimensional space as required to position a region of the substrate 29 properly for exposure. The substrate 29 is mounted to the upstream-facing surface of the wafer chuck 30.

A lithographic exposure using the apparatus of FIG. 3 is performed generally as follows. The reticle 21 is conveyed to a position just downstream of the reticle chuck 22 by a reticle loader (not shown, but well understood in the art). The reticle loader “raises” the reticle 21 to bring the upstream-facing surface 21d of the reticle into contact with the mounting surface 22e of the reticle chuck 22. (To such end, the reticle loader may be configured to move the reticle 21 in a manner that prevents the reticle contacting the catching members 33.) The electrodes 22c are energized by the power source 23, causing the reticle 21 to be attracted electrostatically to, and thus mounted to at a prescribed force, the mounting surface 22e. As described above, actuation of the power source 23 energizes not only electrodes situated in the peripheral portions 22p but also in the large strut 22a. Thus, both peripheral portions 21p and the large strut 21a of the reticle 21 are held fast to the mounting surface 22e.

The reticle loader is returned to a waiting position. Meanwhile, the reticle 21 continues to be held fast to the mounting surface 22e. Because the electrostatic force attracting the reticle 21 to the reticle chuck 22 is sufficiently strong to support the dead weight of the entire reticle, the reticle 21 experiences no sagging relative to the reticle chuck 22. If power to the electrodes 22c ever should be interrupted unintentionally while the reticle 21 is mounted in this manner to the reticle chuck 22, then the catching members 33 would prevent the reticle from falling, thereby preventing damage to the reticle 21.

Meanwhile, a beam of measurement light 25 is projected from the reticle-height sensor 24 to the downstream-facing surface 21c of the reticle 21. Light from the beam 25 reflected from the surface 21c is received by the reticle-height sensor 24. The resulting reticle-height data is processed by a computer (not shown, but understood to be present, connected to, and configured to control operation of the entire microlithography apparatus) to provide accurate reticle-height measurements. Using this data, the computer desirably provides a feedback control scheme for actuations of the reticle stage suitable for maintaining a controlled height of the downstream-facing surface 21c of the reticle relative to the projection-optical system 28.

The illumination beam 24 is irradiated from the source 26 and shaped as required by the illumination-optical system 27, which also irradiates the illumination beam onto a selected region (e.g., subfield) of the reticle 21. For example, the illumination-optical system 27 shapes the illumination beam 24 so as to illuminate, at a given instant, only a single subfield of the reticle 21. As the illumination beam 24 propagates to the selected subfield, the beam passes through the respective open region 22b of the reticle chuck 22. As portions of the illumination beam pass through illuminated subfield, a “patterned beam” is formed, which carries an aerial image of the illuminated subfield. The patterned beam passes through the projection-optical system 28, which uniformly “reduces” (demagnifies) the patterned beam and forms a focused image of the illuminated subfield on a selected region on a “sensitized” surface of the substrate 29. (“Sensitized” means that the upstream-facing surface of the substrate is coated with a material, termed a “resist,” that is imprintable with the aerial image.) Thus, as exposure proceeds from subfield to subfield, the pattern is “transferred” to the substrate 29.

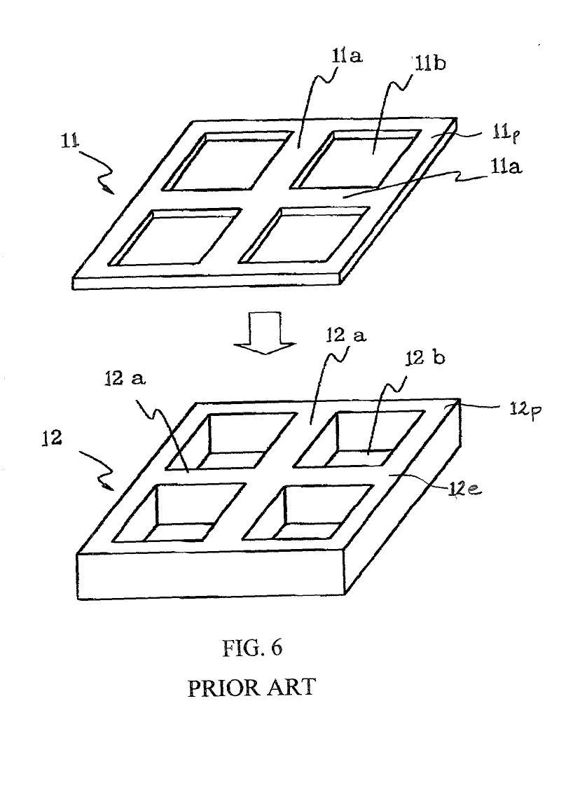

In the foregoing, the reticle chuck was described and depicted as having a single large strut portion 22a (providing a reticle-mounting surface for a corresponding large strut 21a on the reticle 21). The scope of possible configurations of reticle chucks is not limited to reticle chucks having a single large strut portion. One exemplary alternative embodiment has no large strut portions. Another exemplary alternative embodiment has multiple strut portions that are parallel to each other; yet another exemplary alternative embodiment has multiple strut portions that are mutually intersecting (e.g., see FIG. 6), depending upon the configuration of large struts in the respective reticle. In these alternative embodiments each of the strut portions desirably includes one or more electrostatic electrodes or vacuum orifices, as described above, for holding the reticle to the reticle-mounting surface.

In the foregoing description, the illumination beam and patterned beams were denoted as electron beams. However, it will be understood that these beams alternatively can be another type of charged particle beam (e.g., ion beam) or a type of electromagnetic radiation (e.g., light or X-ray) without requiring significant departure from the configuration and operation of the reticle chuck described above. In addition, the foregoing description was made in the context of the reticle 21 being electrostatically attracted to the mounting surface 22e of the reticle chuck 22. As an alternative, the reticle 21 can be held to the mounting surface 22e with similar effect using vacuum.

Also, the foregoing description was made in the context of the reticle 21 being rectangularly shaped. Alternatively, the reticle 21 can have another shape, such as a disk shape, with similar effect. Furthermore, whereas the reticle 21 typically is made from a semiconductor (silicon) wafer, the reticle alternatively can be made of any of various other materials such as gold, diamond, quartz, or glass. If the illumination beam is an X-ray beam, then the reticle typically is made of silicon or a silicon compound. If the illumination beam is light (deep-UV light), then the reticle typically is made of glass or quartz.

Although the catching members 33 are described above as “pawl-shaped” members, it will be understood that the catching members 33 can have any of various other configurations and/or include any of various mechanisms, with similar effect. Any possible configuration of the catching members 33 must be able to function in the intended manner (i.e., catch the reticle to prevent reticle damage) whenever the reticle chuck is unable to hold onto the reticle, such as during malfunctions of the lithography apparatus or power outages.

Whereas the description above is in the context of employing unipolar-type electrostatic attraction for holding the reticle to the mounting surface of the reticle chuck, a bipolar-type of electrostatic attraction alternatively can be used with similar effect. If bipolar electrostatic attraction is used, it is not necessary that the reticle 21 be grounded.

Thus, by increasing the rigidity of the reticle chuck, warping, distortion, and other deformation of the pattern-defining regions of the reticle are prevented whenever the reticle is mounted to the mounting surface of the reticle chuck. Also, because the mounting surface of the reticle chuck faces the projection-optical system, it is easy to measure the distance from the pattern-defining region of the reticle to the projection-optical system. Thus, any profile irregularities of the mounting surface can be measured and corrected easily.

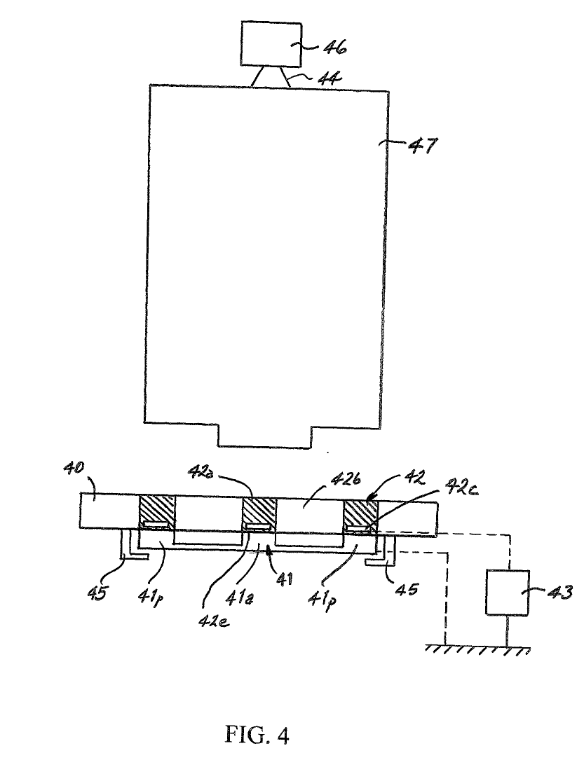

In addition or alternatively to using a reticle holder, as described above, for holding a patterned reticle while making a projection-lithographic exposure, a reticle holder according to the invention can be used for holding a reticle blank while forming a pattern on the reticle blank (to form a patterned reticle). Typically, the pattern is formed on the reticle blank using an electron beam and a reticle-imprinting apparatus as shown generally in FIG. 4. In FIG. 4 an electron beam 44 (or other pattern-imprinting beam) is produced by an electron gun 46 (or other suitable source) situated upstream of an electron-optical system 47 (or other suitable optical system). Downstream of the electron-optical system 47 is a chuck 42, as described above, mounted on a stage 40. The chuck 42 in this embodiment includes electrodes 42c connected to a power source 43. A reticle blank 41, made from a silicon wafer, for example, is attracted electrostatically to the mounting surface 42e of the chuck 42 in the manner generally described above with respect to FIG. 3. Thus, the reticle blank 41 is placed at the imaging plane (focal plane) of the optical system 47. Catching members 43 are provided to prevent the reticle blank 41 from falling in the event, for example, of an unintentional interruption of power to the electrodes 42c.

In a similar manner, a reticle holder (desirably with catching members) can be used for holding a reticle while the reticle is being inspected using a reticle-inspection apparatus. Usually, patterned reticles are inspected using an optical reticle-inspection apparatus including a reticle-positioning device mounted on a holder, in which the reticle is mounted on an upward-facing surfacce of the reticle-positioning device. Under certain conditions it is advantageous when using a reticle-inspection apparatus to hold the reticle on a downward-facing surface of a reticle holder. Under such conditions the reticle-inspection apparatus is provided with a reticle holder such as shown in FIG. 1.

Whereas the invention has been described in the context of representative embodiments, it will be understood that the invention is not limited to those embodiments. On the contrary, the invention is intended to encompass all modifications, alternatives, and equivalents as may be included within the spirit and scope of the invention, as defined by the appended claims.

What is claimed is:

1. A reticle chuck for use in a microlithography apparatus, situated between an upstream illumination-optical system and a downstream projection-optical system of the microlithography apparatus, the reticle chuck comprising a downstream-facing reticle-mounting surface and being configured to hold a reticle on the reticle-mounting surface.

2. The reticle chuck of claim 1, further comprising at least one electrostatic electrode situated relative to the reticle-mounting surface and configured to attract and hold the reticle electrostatically to the reticle-mounting surface.

3. The reticle chuck of claim 1, wherein the reticle-mounting surface defines at least one vacuum orifice connected to a vacuum source and configured to hold the reticle to the reticle-mounting surface by a gas-pressure differential from outside the vacuum orifice to inside the vacuum orifice.

4. The reticle chuck of claim 1, further comprising a catching member situated and configured to catch and hold the reticle at least whenever the reticle has been unintentionally released in a downstream direction from the reticle-mounting surface.

5. The reticle chuck of claim 1, further comprising a peripheral portion and at least one strut portion extending across an open region between opposing members of the peripheral portion, wherein the peripheral portion and strut portion define respective downstream-facing surfaces constituting respective portions of the reticle-mounting surface.

6. The reticle chuck of claim 5, further comprising multiple electrostatic electrodes situated relative to the reticle-mounting surface and configured to attract and hold the reticle electrostatically to the reticle-mounting surface, wherein at least one respective electrode is associated with the downstream-facing surface of the peripheral portion and at least one respective electrode is associated with the downstream-facing surface of the strut portion.

7. The reticle chuck of claim 5, further comprising at least one respective vacuum orifice defined in the downstream-facing surface of the peripheral portion and at least one respective vacuum orifice defined in the downstream-facing surface of the strut portion.

8. In combination:
a reticle; and
a reticle chuck configured to be positioned between an upstream illumination-optical system and a downstream projection-optical system of a microlithography apparatus, the reticle chuck comprising a downstream-facing reticle-mounting surface and being configured to hold the reticle on the reticle-mounting surface.

9. The combination of claim 8, further comprising multiple electrostatic electrodes situated relative to the reticle-mounting surface and configured to attract and hold the reticle electrostatically to the reticle-mounting surface.

10. The combination of claim 8, wherein the reticle-mounting surface defines at least one vacuum orifice connected to a vacuum source and configured to hold the reticle to the reticle-mounting surface by a gas-pressure differential from outside the vacuum orifice to inside the vacuum orifice.

11. The combination of claim 8, wherein the reticle chuck further comprises a peripheral portion and at least one strut portion extending across an open region between opposing members of the peripheral portion, wherein the peripheral portion and strut portion define respective downstream-facing surfaces constituting respective portions of the reticle-mounting surface.

12. The combination of claim 11, further comprising at least one respective electrostatic electrode situated relative to the downstream-facing surface of the peripheral portion and at least one respective electrostatic electrode situated relative to the downstream-facing surface of the strut portion, the electrodes each being configured to attract and hold the reticle electrostatically to the reticle-mounting surface.

13. The combination of claim 11, further comprising at least one respective vacuum orifice defined in the downstream-facing surface of the peripheral portion and at least one respective vacuum orifice defined in the downstream-facing surface of the strut portion, the vacuum orifices being configured to hold the reticle to the reticle-mounting surface by a gas-pressure differential from outside the vacuum orifices to inside the vacuum orifices.

14. The combination of claim 8, further comprising a catching member situated and configured to catch and hold the reticle at least whenever the reticle has been unintentionally released from the reticle-mounting surface.

15. The combination of claim 8, wherein the reticle is fabricated from reticle substrate selected from the group consisting of silicon, silicon compounds, glass, quartz, gold, and diamond.

16. The combination of claim 8, wherein the reticle is a divided reticle.

17. The combination of claim 16, wherein the reticle selected from the group consisting of stencil reticles and membrane reticles.

18. The combination of claim 8, wherein the reticle has an upstream-facing surface configured to be held on the reticle-mounting surface, and a downstream-facing surface.

19. The combination of claim 18, wherein the downstream-facing surface of the reticle is a pattern-defining surface.

20. A microlithography apparatus, comprising:
an illumination optical system;
a projection-optical system; and
a reticle-holding device defining a downstream-facing reticle-mounting surface, the reticle-holding device being situated between the illumination-optical system and the projection-optical system and configured to hold a reticle on the reticle-mounting surface.

21. The apparatus of claim 20, wherein the reticle-holding device further comprises at least one electrostatic electrode situated relative to the reticle-mounting surface and configured to attract and hold the reticle electrostatically to the reticle-mounting surface.

22. The apparatus of claim 21, further comprising a power source connected to the at least one electrode and configured to provide electrical power to the at least one electrode whenever the reticle is to be attracted to the reticle-mounting surface in an electrostatic manner.

23. The apparatus of claim 20, wherein the reticle-mounting surface defines at least one vacuum orifice connected to a vacuum source and configured to hold the reticle to the reticle-mounting surface by a gas-pressure differential from outside the vacuum orifice to inside the vacuum orifice.

24. The apparatus of claim 23, further comprising a vacuum source connected to the at least one vacuum orifice and configured to reduce a gas pressure in the at least one vacuum orifice relative to a gas pressure outside the at least one vacuum orifice whenever the reticle is to be urged in contact with the reticle-mounting surface.

25. The apparatus of claim 20, wherein the reticle-holding device further comprises a catching member situated and configured to catch and hold the reticle at least whenever the reticle has been unintentionally released from the reticle-mounting surface.

26. The apparatus of claim 20, wherein the reticle-holding device further comprises a peripheral portion and at least one strut portion extending across an open region between opposing members of the peripheral portion, wherein the peripheral portion and strut portion define respective downstream-facing surfaces constituting respective portions of the reticle-mounting surface.

27. The apparatus of claim 26, further comprising at least one respective electrostatic electrode situated relative to the downstream-facing surface of the peripheral portion and at least one respective electrostatic electrode situated relative to the downstream-facing surface of the strut portion, the electrodes each being configured to attract and hold the reticle electrostatically to the reticle-mounting surface.

28. The apparatus of claim 26, further comprising at least one respective vacuum orifice defined in the downstream-facing surface of the peripheral portion and at least one respective vacuum orifice defined in the downstream-facing surface of the strut portion, the vacuum orifices being configured to hold the reticle to the reticle-mounting surface by a gas-pressure differential from outside the vacuum orifices to inside the vacuum orifices.

29. The apparatus of claim 20, further comprising a reticle stage to which the reticle-holding device is mounted, the reticle stage being situated and configured to move the reticle-holding device in at least one dimension relative to the illumination-optical system and projection-optical system.

30. The apparatus of claim 20, wherein the illumination-optical system and projection-optical system are configured to pass a charged particle beam.

31. The apparatus of claim 20, wherein the illumination-optical system and projection-optical system are configured to pass a beam of electromagnetic radiation.

32. The apparatus of claim 20, further comprising a reticle-height-measurement device situated and configured to measure a distance from the reticle to the projection-optical system.

33. The apparatus of claim 32, wherein the reticle-height measurement device is configured to direct a laser beam at grazing incidence on the downstream-facing surface of the reticle.

34. In a method for performing microlithography in which an energy beam is passed through an illumination-optical system to a reticle and from the reticle through a projection-optical system to a substrate, a method for holding the reticle relative to the energy beam, comprising:
situating a reticle chuck between the illumination-optical system and the projection-optical system, the reticle chuck comprising a downstream-facing reticle-mounting surface configured for holding an upstream-facing surface of the reticle; and
mounting the reticle to the reticle chuck.

35. The method of claim 34, wherein the step of mounting the reticle to the reticle chuck comprises attaching the upstream-facing surface of the reticle to the reticle-mounting surface by electrostatic attraction.

36. The method of claim 34, wherein the step of mounting the reticle to the reticle chuck comprises attaching the upstream-facing surface of the reticle to the reticle-mounting surface by vacuum suction.

37. The method of claim 34, wherein:
the reticle chuck is configured with a peripheral portion and at least one strut portion extending across an open region between opposing members of the peripheral portion;
the peripheral portion and strut portion define respective downstream-facing surfaces constituting respective portions of the reticle-mounting surface; and
the step of mounting the reticle to the reticle chuck comprises attaching the upstream-facing surface of the reticle to the respective portions of the reticle-mounting surface on the peripheral portion and strut portion.

38. In combination:
a reticle blank; and
a chuck configured to be positioned downstream of an optical system of a reticle-imprinting apparatus, the chuck comprising a downstream-facing mounting surface and being configured to hold the reticle blank, at an imaging plane of the optical system, on the mounting surface as the reticle blank is being inscribed with a pattern by a pattern-inscribing beam passing through the optical system.

39. In a method for inscribing a pattern on a reticle blank using an inscribing beam that is passed through an inscribing-optical system, a method for holding the reticle blank relative to the inscribing beam, comprising:
situating a chuck downstream of the inscribing-optical system, the chuck comprisng a downstream-facing mounting surface configured for holding an upstream-facing surface of the reticle blank such that the reticle blank is at an imaging plane of the inscribing-optical system; and
mounting the reticle blank to the mounting surface.
